(19) United States
(12) Patent Application Publication
(10) Pub. No.: US 2019/0291862 A1
(43) Pub. Date: Sep. 26, 2019

(54) SELF-PILOTED AIRCRAFT FOR PASSENGER OR CARGO TRANSPORTATION

(71) Applicant: A^3 BY AIRBUS LLC, Santa Clara, CA (US)

(72) Inventors: Rodin Lyasoff, San Francisco, CA (US); Geoffrey C. Bower, Sunnyvale, CA (US); Zachary Lovering, Sunnyvale, CA (US)

(73) Assignee: A^3 BY AIRBUS LLC, Santa Clara, CA (US)

(21) Appl. No.: 16/302,263

(22) PCT Filed: Feb. 16, 2017
(86) PCT No.: PCT/US2017/018182

§ 371 Date: Nov. 16, 2018

Related U.S. Application Data
(60) Provisional application No. 62/338,294, filed on May 18, 2016.
(60) Provisional application No. 62/338,273, filed on May 18, 2016.

(51) Int. Cl. B64C 29/00; B64D 31/06

(52) U.S. Cl. CPC B64C 29/0033; B64C 39/024; B64D 31/06

(57) ABSTRACT

The present disclosure pertains to self-piloted, electric vertical takeoff and landing (VTOL) aircraft that are safe, low-noise, and cost-effective to operate for cargo-carrying and passenger-carrying applications over relatively long ranges. A VTOL aircraft has a tandem-wing configuration with one or more propellers mounted on each wing to provide propeller redundancy, allowing sufficient propulsion and control to be maintained in the event of a failure of any of the propellers or other flight control devices. The arrangement also allows the propellers to be electrically-powered, yet capable of providing sufficient thrust with a relatively low blade speed, which helps to reduce noise. In addition, the aircraft is aerodynamically designed for efficient flight dynamics with redundant controls for yaw, pitch, and roll.

### CROSS REFERENCE TO RELATED APPLICATIONS

This application claims priority to U.S. Provisional Application No. 62/338,273, entitled “Vertical Takeoff and Landing Aircraft with Tilted-Wing Configurations” and filed on May 18, 2016, which is incorporated herein by reference. This application also claims priority to U.S. Provisional Application No. 62/338,294, entitled “Autonomous Aircraft for Passenger or Cargo Transportation” and filed on May 18, 2016, which is incorporated herein by reference.

### BACKGROUND

Vertical takeoff and landing (VTOL) aircraft offer various advantages over other types of aircraft that require a runway. However, the design of VTOL aircraft can be complex making it challenging to design VTOL aircraft that are cost-effective and safe for carrying passengers or cargo. As an example, a helicopter is a common VTOL aircraft that has been conventionally used to transport passengers and cargo. In general, helicopters use a large rotor to generate both lift and forward thrust, requiring the rotor to operate at high speeds. The design of the rotor can be complex, and failure of the rotor can be catastrophic. In addition, operation of a large rotor at high speeds generates a significant amount of noise that can be a nuisance and potentially limit the geographic regions at which the helicopter is permitted to operate. Helicopters also can be expensive to manufacture and operate, requiring a significant amount of fuel, maintenance, and the services of a skilled pilot.

Due to the shortcomings and costs of conventional helicopters, electrically-powered VTOL aircraft, such as electric helicopters and unmanned aerial vehicles (UAVs), have been considered for certain passenger-carrying and cargo-carrying applications. Using electrical power to generate thrust and lift may help somewhat to reduce noise, but it is has proven challenging to design electric VTOL aircraft that are capable of accommodating the weight required for many applications involving the transport of passengers or cargo without unduly limiting the aircraft's range. Also, operational expenses can be lowered if VTOL aircraft can be designed to be self-piloted, without requiring the services of a human pilot. However, safety is a paramount concern, and many consumers are wary of self-piloted aircraft for safety reasons.

A heretofore unaddressed need exists in the art for a self-piloted, electrically-powered, VTOL aircraft that is safe, low-noise, and cost-effective to operate for cargo-carrying and passenger-carrying applications over relatively long ranges.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 depicts a perspective view of a self-piloted VTOL aircraft in accordance with some embodiments of the present disclosure.

FIG. 2A depicts a front view of a self-piloted VTOL aircraft, such as is depicted by FIG. 1, with flight control surfaces actuated for controlling roll and pitch.

FIG. 2B depicts a perspective view of a self-piloted VTOL aircraft, such as is depicted by FIG. 2A.

FIG. 3 is a block diagram illustrating various components of a VTOL aircraft, such as is depicted by FIG. 1.

FIG. 4 is a block diagram illustrating a flight-control actuation system, such as is depicted by FIG. 3, in accordance with some embodiments of the present disclosure.

FIG. 5 depicts a perspective view of a self-piloted VTOL aircraft, such as is depicted by FIG. 1, in a hover configuration in accordance with some embodiments of the present disclosure.

FIG. 6 depicts a top view of a self-piloted VTOL aircraft, such as is depicted by FIG. 5, in a hover configuration with the wings tilted such that thrust from wing-mounted propellers is substantially vertical.

FIG. 7 depicts a block diagram illustrating collision avoidance sensors in accordance with some embodiments of the present disclosure.

FIG. 8 depicts a flow chart illustrating a method for sensing and avoiding collisions.

FIG. 9 is a flow chart illustrating a method for controlling a self-piloted VTOL aircraft, such as is depicted by FIG. 1 in accordance with some embodiments of the present disclosure.

FIG. 10 depicts a perspective view of a self-piloted VTOL aircraft, such as is depicted by FIG. 1, equipped with a cargo module in accordance with some embodiments of the present disclosure.

FIG. 11 depicts a perspective view of a self-piloted VTOL aircraft, such as is depicted by FIG. 1, from which batteries have been removed in accordance with some embodiments of the present disclosure.

FIG. 12 depicts a perspective view of a self-piloted VTOL aircraft, such as is depicted by FIG. 11, where batteries have been inserted into a compartment of a fuselage in accordance with some embodiments of the present disclosure.

FIG. 13 depicts a top view of a self-piloted VTOL aircraft in a hover configuration in accordance with some embodiments of the present disclosure.

### DETAILED DESCRIPTION

The present disclosure generally pertains to vertical takeoff and landing (VTOL) aircraft that have tilted-wing configurations. A self-piloted, electric, VTOL aircraft in accordance with some embodiments of the present disclosure has a tandem-wing configuration with one or more propellers mounted on each wing in an arrangement that provides propeller redundancy, allowing sufficient propulsion and control to be maintained in the event of a failure of one or more of the propellers or other flight control devices. The arrangement also allows the propellers to be electrically-powered, yet capable of providing sufficient thrust with a relatively low blade speed, which helps to reduce noise.

In addition, each wing is designed to tilt, thereby rotating the propellers, as the aircraft transitions between a forward-flight configuration and a hover configuration. In this regard, for the forward-flight configuration, the propellers are positioned to provide forward thrust while simultaneously blowing air over the wings so as to improve the lift characteristics (e.g., lift-to-drag ratio) of the wings and also help keep the wing dynamics substantially linear, thereby reducing the likelihood of stalls. For the hover configuration, the wings are tilted in order to position the propellers to provide upward thrust for controlling vertical movement of the aircraft. While in the hover configuration, the wings and propellers may be offset from vertical to provide efficient yaw control.

Specifically, in the hover configuration, the propellers may be slightly offset from vertical in order to generate horizontal thrust components that can be used to induce movements about the yaw axis, as may be desired. The wings also may have movable flight control surfaces that can be adjusted to redirect the airflow from the propellers to provide additional yaw control in the hover configuration. These same flight control surfaces may be used to provide pitch and roll control in the forward-flight configuration. During a transition from the hover configuration to the forward-flight configuration, the tilt of the wings can be adjusted in order to keep the wings substantially aligned with the aircraft's flight path further helping to keep the wing dynamics linear and prevent a stall.

Accordingly, a self-piloted, electric, VTOL aircraft having improved safety and performance can be realized. Using the configurations described herein, it is possible to design a self-piloted, electric, VTOL aircraft that is safe and low-noise. An exemplary aircraft designed to the teachings of this application can have a small footprint (e.g., a tip-to-tip wingspan of about 11 meters) and mass (e.g., about 600 kilograms) and is capable of supporting a payload of about 100 kilograms over a range of up to about 80 kilometers at speeds of about 90 knots. Further, such an aircraft may be designed to produce a relatively low amount of noise such as about 61 decibels as measured on the ground when the aircraft is at approximately 100 feet. The same or similar design may be used for aircraft of other sizes, weights, and performance characteristics.

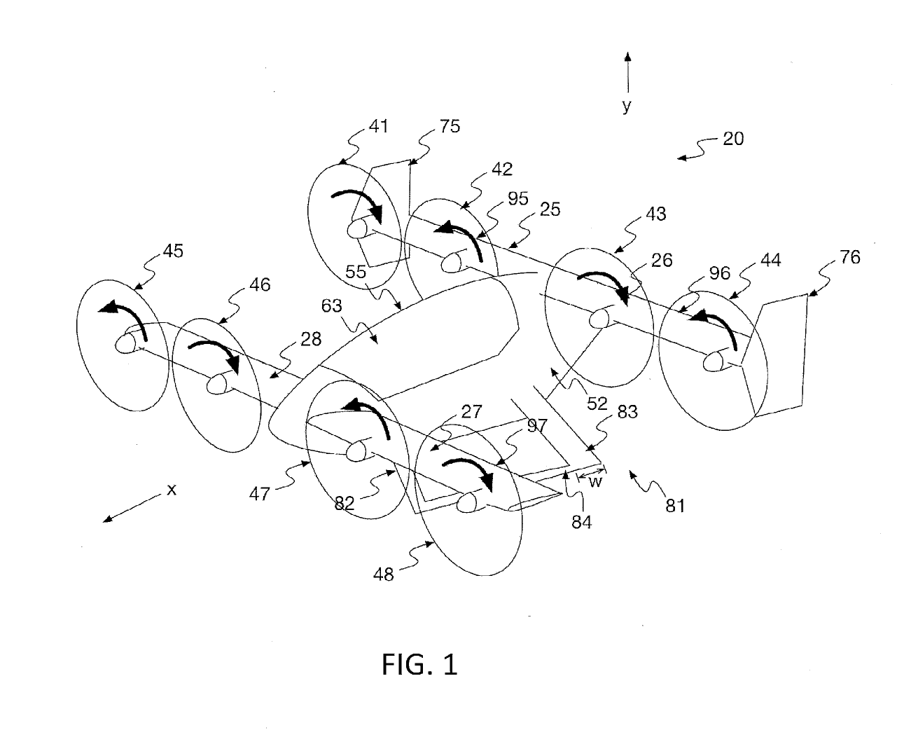

FIG. 1 depicts a VTOL aircraft 20 in accordance with some embodiments of the present disclosure. The aircraft 20 is autonomous or self-piloted in that it is capable of flying passengers or cargo to selected destinations under the direction of an electronic controller without the assistance of a human pilot. As used herein, the terms “autonomous” and “self-piloted” are synonymous and shall be used interchangeably. Further, the aircraft 20 is electrically powered thereby helping to reduce operation costs. Any conventional way of providing electrical power is contemplated. If desired, the aircraft 20 may be equipped to provide a passenger with flight control so that the passenger may pilot the aircraft at least temporarily rather than rely exclusively on self-piloting by a controller.

As shown by FIG. 1, the aircraft 20 has a tandem-wing configuration with a pair of rear wings 25, 26 mounted close to the rear of a fuselage 33 and a pair of forward wings 27, 28, which may also be referred to as “canards,” mounted close to the front of the fuselage 33. Each wing 25-28 has camber and generates lift (in the y-direction) when air flows over the wing surfaces. The rear wings 25, 26 are mounted higher than the forward wings 27, 28 so as to keep them out of the wake of the forward wings 27, 28.

In the tandem-wing configuration, the center of gravity of the aircraft 20 is between the rear wings 25, 26 and the forward wings 27, 28 such that the moments generated by lift from the rear wings 25, 26 counteract the moments generated by lift from the forward wings 27, 28 in forward flight. Thus, the aircraft 20 is able to achieve pitch stability without the need of a horizontal stabilizer that would otherwise generate lift in a downward direction, thereby inefficiently counteracting the lift generated by the wings. In some embodiments, the rear wings 25, 26 have the same wingspan, aspect ratio, and mean chord as the forward wings 27, 28, but the sizes and configurations of the wings may be different in other embodiments.

The forward wings 27, 28 may be designed to generate more lift than the rear wings 25, 26, such as by having a slightly higher angle of attack or other wing characteristics different than the rear wings 25, 26. As an example, in some embodiments, the forward wings 27, 28 may be designed to carry about 60% of the aircraft's overall load in forward flight. Having a slightly higher angle of attack also helps to ensure that the forward wings 27, 28 stall before the rear wings 25, 26, thereby providing increased stability. In this regard, if the forward wings 27, 28 stall before the rear wings 25, 26, then the decreased lift on the forward wings 27, 28 resulting from the stall should cause the aircraft 20 to pitch forward since the center of gravity is between the forward wings 27, 28 and the rear wings 25, 26. In such event, the downward movement of the aircraft's nose should reduce the angle of attack on the forward wings 27, 28, breaking the stall.

In some embodiments, each wing 25-28 has a tilted-wing configuration that enables it to be tilted relative to the fuselage 33. In this regard, as will be described in more detail below, the wings 25-28 are rotatably coupled to the fuselage 33 so that they can be dynamically tilted relative to the fuselage 33 to provide vertical takeoff and landing (VTOL) capability and other functions, such as yaw control and improved aerodynamics, as will be described in more detail below.

A plurality of propellers 41-48 are mounted on the wings 25-28. In some embodiments, two propellers are mounted on each wing 25-28 for a total of eight propellers 41-48, as shown by FIG. 1, but other numbers of propellers 41-48 are possible in other embodiments. Further, it is unnecessary for each propeller to be mounted on a wing. As an example, the aircraft 20 may have one or more propellers (not shown) that are coupled to the fuselage 33, such as at a point between the forward wings 27, 28 and the rear wings 25, 26, by a structure (e.g., a rod or other structure) that does not generate lift. Such a propeller may be rotated relative to the fuselage 33 by rotating the rod or other structure that couples the propeller to the fuselage 33 or by other techniques.

For forward flight, the wings 25-28 and propellers 41-48 are positioned as shown by FIG. 1 such that thrust generated by the propellers 41-48 is substantially horizontal (in the x-direction) for moving the aircraft 20 forward. Further, each propeller 41-48 is mounted on a respective wing 25-28 and is positioned in front of the wing's leading edge such that the propeller blows air over the surfaces of the wing, thereby improving the wing's lift characteristics. For example, propellers 41, 42 are mounted on and blow air over the surfaces of wing 25; propellers 43, 44 are mounted on and blow air over the surfaces of wing 26; propellers 45, 46 are mounted on and blow air over the surfaces of wing 28; and propellers 47, 48 are mounted on and blow air over the surfaces of wing 27. Rotation of the propeller blades, in addition to generating thrust, also increases the speed of the airflow around the wings 25-28 such that more lift is generated by the wings 25-28 for a given airspeed of the aircraft 20. In other embodiments, other types of propulsion devices may be used to generate thrust it, and it is unnecessary for each wing 25-28 to have a propeller or other propulsion device mounted thereon.

In some embodiments, the blades of the propellers 41-48 are sized such that nearly the entire width of each wing 25-28 is blown by the propellers 41-48. As an example, the blades of the propellers 41, 42 in combination span across nearly the entire width of the wing 25 such that air is blown by the propellers 41, 42 across the entire width or nearly the entire width (e.g., about 90% or more) of the wing 25. Further, the blades of the propellers 43-48 for the other wings 26-28 similarly span across nearly the entire widths of the wings 26-28 such that air is blown by the propellers 43-48 across the entire width or nearly the entire width of each wing 26-28. Such a configuration helps to increase the performance improvements described above for blown wings. However, in other embodiments, air can be blown across a smaller width for any wing 25-28, and it is unnecessary for air to be blown over each wing 25-28.

As known in the art, when an airfoil is generating aerodynamic lift, a vortex (referred to as a “wingtip vortex”) is typically formed by the airflow passing over the wing and rolls off of the wing at the wingtip. Such a wingtip vortex is associated with a significant amount of induced drag that generally increases as the intensity of the wingtip vortex increases.

The end of each rear wing 25, 26 forms a respective winglet 75, 76 that extends generally in a vertical direction. The shape, size, and orientation (e.g., angle) of the winglets 75, 76 can vary in different embodiments. In some embodiments, the winglets 75, 76 are flat airfoils (without camber), but other types of winglets are possible. As known in the art, a winglet 75, 76 can help to reduce drag by smoothing the airflow near the wingtip helping to reduce the intensity of the wingtip vortex. The winglets 75, 76 also provide lateral stability about the yaw axis by generating aerodynamic forces that tend to resist yawing during forward flight. In other embodiments, the use of winglets 75, 76 is unnecessary, and other techniques may be used to control or stabilize yaw. Also, winglets may be formed on the forward wings 27, 28 in addition to or instead of the rear wings 25, 26.

In some embodiments, at least some of the propellers 41, 44, 45, 48 are wing-tip mounted. That is, the propellers 41, 44, 45, 48 are mounted at the ends of wings 25-28, respectively, near the wingtips such that these propellers 41, 44, 45, 48 blow air over the wingtips. The blades of the propellers 45, 48 at the ends of the forward wings 27, 28 rotate counter-clockwise and clockwise, respectively, when viewed from the front of the aircraft 20. Thus, the blades of the propellers 45, 48 are moving in a downward direction when they pass the wingtip (i.e., on the outboard side of the propeller 45, 48), and such blades are moving in an upward direction when they pass the wing 27, 28 on the inboard side of the propeller 45, 48. As known in the art, a propeller generates a downwash (i.e., a deflection of air in a downward direction) on one side where the propeller blades are moving downward and an upwash (i.e., a deflection of air in an upward direction) on a side where the propeller blades are moving upward. An upwash flowing over a wing tends to increase the effective angle of attack for the portion of the wing over which the upwash flows, thereby often causing such portion to generate more lift, and a downwash flowing over a wing tends to decrease the effective angle of attack for the portion of the wing over which the downwash flows, thereby often causing such portion to generate less lift.

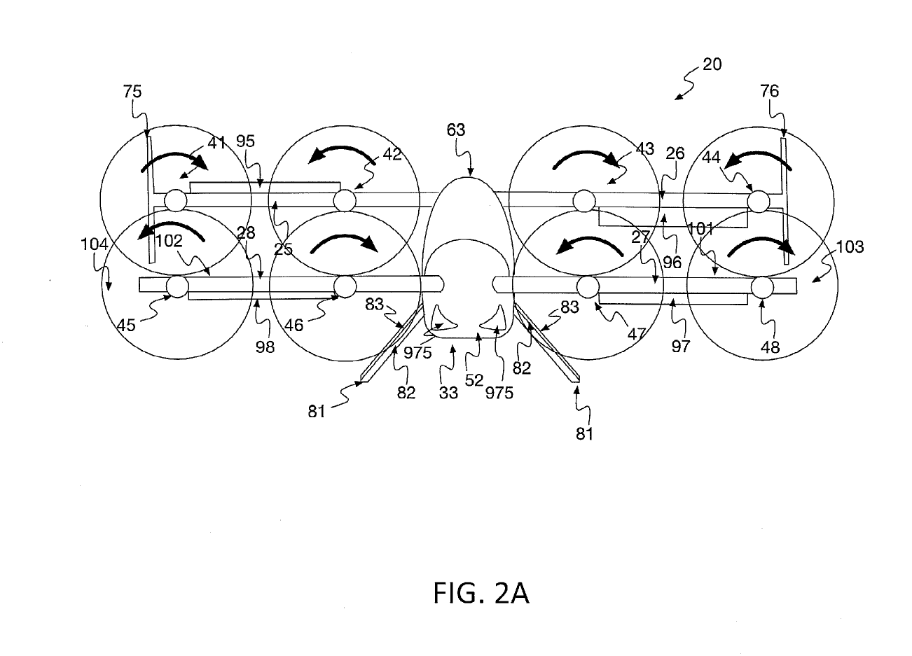

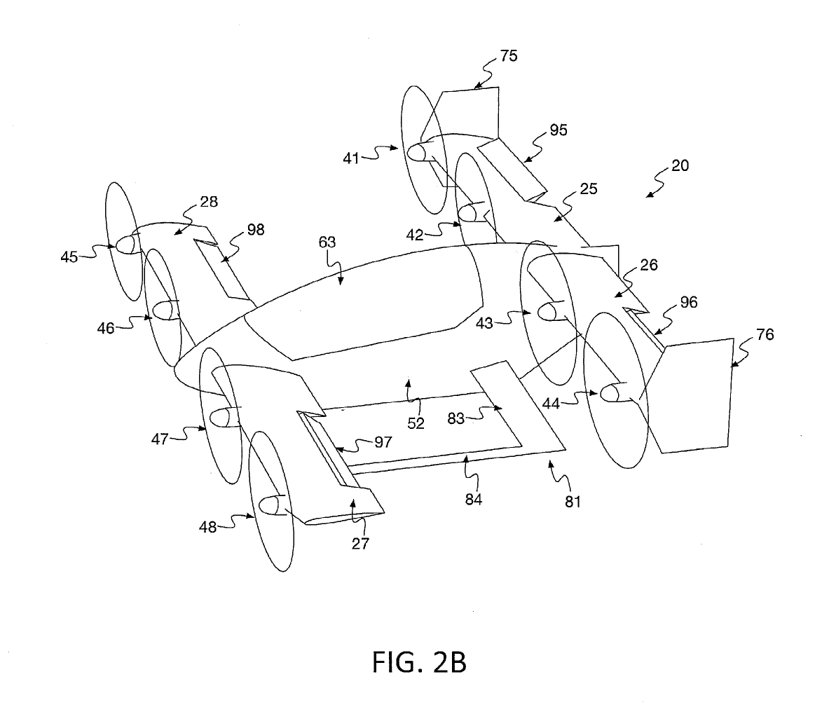

Due to the direction of blade rotation of the propellers 45, 48, each of the propellers 45, 48 generates an upwash on its inboard side and downwash on its outboard side. The portions of the wings 27, 28 behind the propellers 45, 48 on their inboard sides (indicated by reference arrows 101, 102 in FIG. 2A) generate increased lift due to the upwash from the propellers 45, 48. Further, due to the placement of the propellers 45, 48 at the wingtips, a substantial portion of the downwash of each propeller 45, 48 does not pass over a forward wing 27, 28 but rather flows in a region (indicated by reference arrows 103, 104 in FIG. 2A) outboard from the wingtip. Thus, for each forward wing 27, 28, increased lift is realized from the upwash of one of the propellers 45, 48 without incurring a comparable decrease in lift from the downwash, resulting in a higher lift-to-drag ratio.

For controllability reasons, which will be described in more detail below, it may be desirable to design the aircraft 20 such that the outer propellers 41, 44 on the rear wings 25, 26 do not rotate their blades in the same direction and the outer propellers 45, 48 on the forward wings 27, 28 do not rotate their blades in the same direction. Thus, in some embodiments, the outer propellers 44, 45 rotate their blades in a counter-clockwise direction opposite to that of the propellers 41, 48. In such embodiments, the placement of the propellers 41, 44 at the wingtips does not have the same performance benefits described above for the outer propellers 45, 48 of the forward wings 27, 28. However, blowing air on the winglets 75, 76 provides at least some performance improvement associated with the winglets 75, 76. More specifically, the upwash from the propellers 41, 44 is in a direction close to the direction of lift of the winglets 75, 76. This allows the winglets 75, 76 to be designed smaller for a desired level of stability resulting in less drag from the winglets 75, 76. In addition, in embodiments for which the forward wings 27, 28 are designed to provide more lift than the rear wings 25, 26, as described above, selecting outer propellers 45, 48 on the forward wings 27, 28 to realize the performance benefits associated with wingtip-mounting results in a more efficient configuration. In this regard, such performance benefits have a greater overall effect when applied to a wing generating greater lift.

The fuselage 33 comprises a frame 52 on which a removable passenger module 55 and the wings 25-28 are mounted. The passenger module 55 has a floor (not shown in FIG. 1) on which at least one seat (not shown in FIG. 1) for at least one passenger is mounted. The passenger module 55 also has a transparent canopy 63 through which a passenger may see. As will be described in more detail hereafter, the passenger module 55 may be removed from the frame 52 and replaced with a different module (e.g., a cargo module) for changing the utility of the aircraft 20, such as from passenger-carrying to cargo-carrying.

As shown by FIG. 1, the illustrative aircraft has landing struts 83, referred to herein as “rear struts,” that are aerodynamically designed for providing lateral stability about the yaw axis. In this regard, the rear struts 83 form flat airfoils (without camber) that generate aerodynamic forces that tend to resist yawing during forward flight. In other embodiments, the rear struts 83 may form other types of airfoils as may be desired. In the embodiment depicted by FIG. 1, each rear strut 83 forms part of a respective landing skid 81 that has a forward strut 82 joined to the strut 83 by a horizontal bar 84. In other embodiments, the landing gear may have other configurations. For example, rather than using a skid 81, the rear struts may be coupled to wheels. The use of the rear struts 83 for providing lateral stability permits the size of the winglets 75, 76 to be reduced, thereby reducing drag induced by the winglets 75, 76, while still achieving a desired level of yaw stability. In some embodiments, the height of each winglet 75, 76 is equal to or less than the propeller radius (i.e., distance from the propeller center of rotation to the propeller tip) in order to keep the lifting surfaces of the winglets 75, 76 inside the propeller slipstream.

As shown by FIG. 1, the wings 25-28 have hinged flight control surfaces 95-98, respectively, for controlling the roll and pitch of the aircraft 20 during forward flight. FIG. 1 shows each of the flight control surface 95-98 in a neutral position for which each flight control surface 95-98 is aligned with the remainder of the wing surface. Thus, airflow is not significantly redirected or disrupted by the flight control surfaces 95-98 when they are in the neutral position. Each flight control surface 95-98 may be rotated upward, which has the effect of decreasing lift, and each flight control surface 95-98 may be rotated downward, which has the effect of increasing lift.

In some embodiments, the flight control surfaces 95, 96 of rear wings 25, 26 may be used to control roll, and the flight control surfaces 97, 98 of forward wings 27, 28 may be used to control pitch. In this regard, to roll the aircraft 20, the flight control surfaces 95, 96 may be controlled in an opposite manner during forward flight such that one of the flight control surfaces 95, 96 is rotated downward while the other flight control surface 95, 96 is rotated upward, as shown by FIGS. 2A and 2B, depending on which direction the aircraft 20 is to be rolled. The downward-rotated flight control surface 95 increases lift, and the upward-rotated flight control surface 96 decreases lift such that the aircraft 20 rolls toward the side on which the upward-rotated flight control surface 96 is located. Thus, the flight control surfaces 95, 96 may function as ailerons in forward flight.

The flight control surface 97, 98 may be controlled in unison during forward flight. When it is desirable to increase the pitch of the aircraft 20, the flight control surfaces 97, 98 are both rotated downward, as shown by FIGS. 2A and 2B, thereby increasing the lift of the wings 27, 28. This increased lift causes the nose of the aircraft 20 to pitch upward. Conversely, when it is desirable for the aircraft 20 to pitch downward, the flight control surfaces 97, 98 are both rotated upward thereby decreasing the lift generated by the wings 27, 28. This decreased lift causes the nose of the aircraft 20 to pitch downward. Thus, the flight control surfaces 97, 98 may function as elevators in forward flight.

Note that the flight control surfaces 95-98 may be used in other manners in other embodiments. For example, it is possible for the flight control surfaces 97, 98 to function as ailerons and for the flight control surfaces 95, 96 to function as elevators. Also, it is possible for any flight control surface 95-98 to be used for one purpose (e.g., as an aileron) during one time period and for another purpose (e.g., as an elevator) during another time period. Indeed, it is possible for any of the flight control surfaces 95-98 to control yaw depending on the orientation of the wings 25-28.

During forward flight, pitch, roll, and yaw may also be controlled via the propellers 41-48. As an example, to control pitch, the controller 110 may adjust the blade speeds of the propellers 45-48 on the forward wings 27, 28. An increase in blade speed increases the velocity of air over the forward wings 27, 28, thereby increasing lift on the forward wings 27, 28 and, thus, increasing pitch. Conversely, a decrease in blade speed decreases the velocity of air over the forward wings 27, 28, thereby decreasing lift on the forward wings 27, 28 and, thus, decreasing pitch. The propellers 41-44 may be similarly controlled to provide pitch control. In addition, increasing the blade speeds on one side of the aircraft 20 and decreasing the blade speeds on the other side can cause roll by increasing lift on one side and decreasing lift on the other. It is also possible to use blade speed to control yaw. Having redundant mechanisms for flight control helps to improve safety. For example, in the event of a failure of one or more flight control surfaces 95-98, the controller 110 may be configured to mitigate for the failure by using the blade speeds of the propellers 41-48.

It should be emphasized that the wing configurations described above, including the arrangement of the propellers 41-48 and flight control surfaces 95-98, as well as the size, number, and placement of the wings 25-28, are only examples of the types of wing configurations that can be used to control the aircraft's flight. Various modifications and changes to the wing configurations described above would be apparent to a person of ordinary skill upon reading this disclosure.

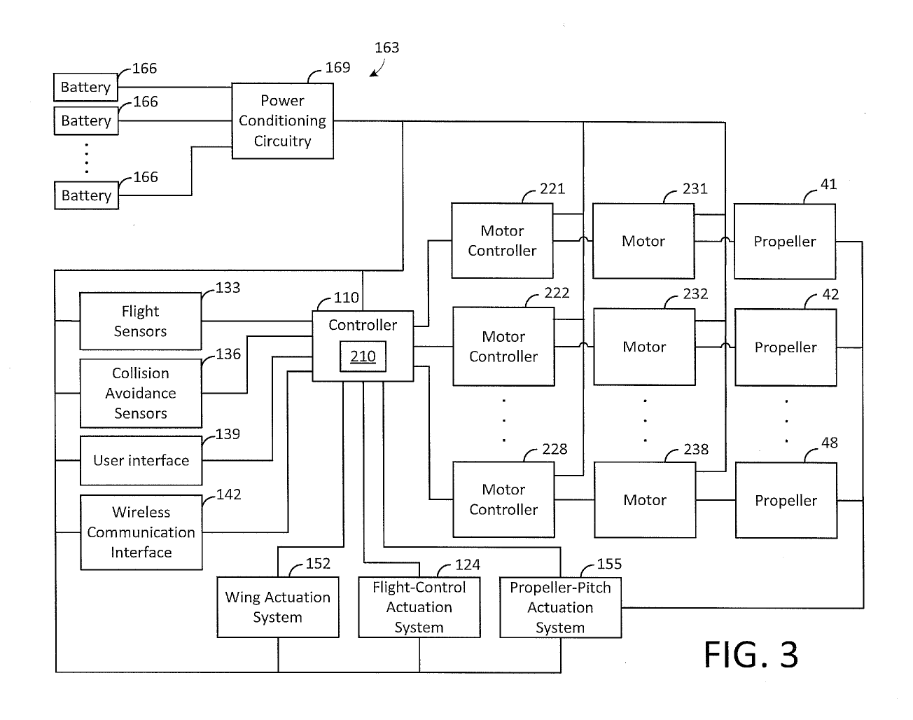

Referring to FIG. 3, the aircraft 20 may operate under the direction and control of an onboard controller 110, which may be implemented in hardware or any combination of hardware, software, and firmware. The controller 110 may be configured to control the flight path and flight characteristics of the aircraft 20 by controlling at least the propellers 41-48, the wings 25-28, and the flight control surfaces 95-98, as will be described in more detail below.

The controller 110 is coupled to a plurality of motor controllers 221-228 where each motor controller 221-228 is configured to control the blade speed of a respective propeller 41-48 based on control signals from the controller 110. As shown by FIG. 3, each motor controller 221-228 is coupled to a respective motor 231-238 that drives a corresponding propeller 41-48. When the controller 110 determines to adjust the blade speed of a propeller 41-48, the controller 110 transmits a control signal that is used by a corresponding motor controller 221-238 to set the rotation speed of the propeller's blades, thereby controlling the thrust provided by the propeller 41-48.

As an example, to set the blade speed of the propeller 41, the controller 110 transmits a control signal indicative of the desired blade speed to the corresponding motor controller 221 that is coupled to the propeller 41. In response, the motor controller 221 provides at least one analog signal for controlling the motor 231 such that it appropriately drives the propeller 41 to achieve the desired blade speed. The other propellers 42-48 can be controlled in a similar fashion. In some embodiments, each motor controller 221-228 (along with its corresponding motor 231-238) is mounted within a wing 25-28 directly behind the respective propeller 41-48 to which it is coupled. Further, the motor controllers 221-228 and motors 231-238 are passively cooled by directing a portion of the airflow through the wings and over heat sinks (not shown) that are thermally coupled to the motor controllers 221-228 and motors 231-238.

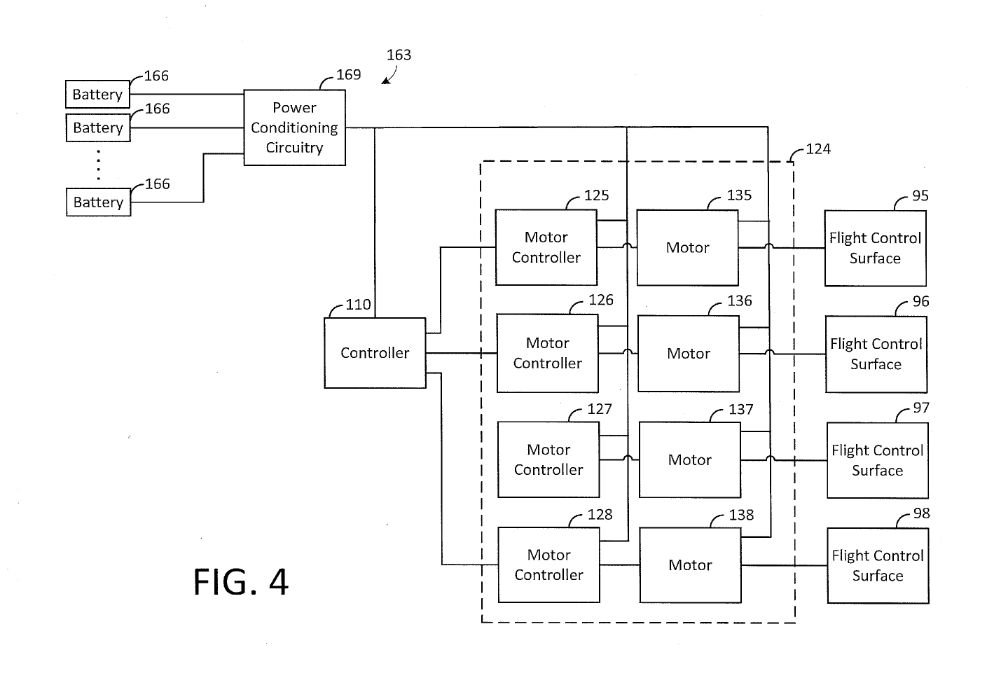

The controller 110 is also coupled to a flight-control actuation system 124 that is configured to control movement of the flight control surfaces 95-98 under the direction and control of the controller 110. FIG. 4 depicts an embodiment of the flight-control actuation system 124. As shown by FIG. 4, the system 124 comprises a plurality of motor controllers 125-128, which are coupled to a plurality of motors 135-138 that control movement of the flight control surfaces 95-98, respectively. The controller 110 is configured to provide control signals that can be used to set the positions of the flight control surfaces 95-98 as may be desired.

As an example, to set the position of the flight control surface 95, the controller 110 transmits a control signal indicative of the desired position to the corresponding motor controller 125 that is coupled to the flight control surface 95. In response, the motor controller 125 provides at least one analog signal for controlling the motor 135 such that it appropriately rotates the flight control surface 95 to the desired position. The other flight control surfaces 96-98 can be controlled in a similar fashion.

As shown by FIG. 3, to assist the controller 110 in its control functions, the aircraft 20 may have a plurality of flight sensors 133 that are coupled to the controller 110 and that provide the controller 110 with various inputs on which the controller 110 may make control decisions. As an example, the flight sensors 133 may include an airspeed sensor, an attitude sensor, a heading sensor, an altimeter, a vertical speed sensor, a global positioning system (GPS) receiver, or any other type of sensor that may be used for making control decisions for aviating and navigating the aircraft 20.

The aircraft 110 may also have collision avoidance sensors 136 that are used to detect terrain, obstacles, aircraft, and other objects that may pose a collision threat. The controller 110 is configured to use information from the collision avoidance sensors 136 in order to control the flight path of the aircraft 20 so as to avoid a collision with objects sensed by the sensors 136.

As shown by FIG. 3, the aircraft 20 may have a user interface 139 that can be used to receive inputs from or provide outputs to a user, such as a passenger. As an example, the user interface 139 may comprise a keyboard, keypad, mouse, or other device capable of receiving inputs from a user, and the user interface 139 may comprise a display device or a speaker for providing visual or audio outputs to the user. In some embodiments, the user interface 139 may comprise a touch-sensitive display device that has a display screen capable of displaying outputs and receiving touch inputs. As will be described in more detail below, a user may utilize the user interface 139 for various purposes, such as selecting or otherwise specifying a destination for a flight by the aircraft 20.

The aircraft 20 also has a wireless communication interface 142 for enabling wireless communication with external devices. The wireless communication interface 142 may comprise one or more radio frequency (RF) radios, cellular radios, or other devices for communicating across long ranges. As an example, during flight, the controller 110 may receive control instructions or information from a remote location and then control the operation of the aircraft 20 based on such instructions or information. The controller 110 may also comprise short-range communication devices, such as Bluetooth devices, for communicating across short ranges. As an example, a user may use a wireless device, such as cellular telephone, to provide input in lieu of or in addition to user interface 139. The user may communicate with the controller 110 using long range communication or alternatively using short range communication, such as when the user is physically present at the aircraft 20.

As shown by FIG. 3, the controller 110 is coupled to a wing actuation system 152 that is configured to rotate the wings 25-28 under the direction and control of the controller 110. In addition, the controller 110 is coupled to a propeller-pitch actuation system 155, which may be used to control the pitch of the blades of the propellers as may be desired in order to achieve efficient flight characteristics.

As further shown by FIG. 3, the aircraft 20 has an electrical power system 163 for powering various components of the aircraft 20, including the controller 110, the motor controllers 221-228, 125-128, and the motors 231-238, 135-138. In some embodiments, the motors 231-238 for driving the propellers 41-48 are exclusively powered by electrical power from the system 163, but it is possible for other types of motors 231-238 (e.g., fuel-fed motors) to be used in other embodiments.

The electrical system 163 has distributed power sources comprising a plurality of batteries 166 that are mounted on the frame 52 at various locations. Each of the batteries 166 is coupled to power conditioning circuitry 169 that receives electrical power from the batteries 166 and conditions such power (e.g., regulates voltage) for distribution to the electrical components of the aircraft 20. Specifically, the power conditioning circuitry 169 combines electrical power from multiple batteries 166 to provide at least one direct current (DC) power signal for the aircraft's electrical components. If any of the batteries 166 fail, the remaining batteries 166 may be used to satisfy the power requirements of the aircraft 20.

As indicated above, the controller 110 may be implemented in hardware, software, or any combination thereof. In some embodiments, the controller 110 includes at least one processor and software for running on the processor in order to implement the control functions described herein for the controller 110. Other configurations of the controller 110 are possible in other embodiments. Note that it is possible for the control functions to be distributed across multiple processors, such as multiple onboard processors, and for the control functions to be distributed across multiple locations. As an example, some control functions may be performed at one or more remote locations, and control information or instructions may be communicated between such remote locations and the aircraft 20 by the wireless communication interface 142 (FIG. 3) or otherwise.

As shown by FIG. 3, the controller 110 may store or otherwise have access to flight data 210, which may be used by the controller 110 for controlling the aircraft 20. As an example, the flight data 210 may define one or more predefined flight paths that can be selected by a passenger or other user. Using the flight data 210, the controller 110 may be configured to self-pilot the aircraft 20 to fly the selected flight path in order to reach a desired destination, as will be described in more detail hereafter.

As described above, in some embodiments, the wings 25-28 are configured to rotate under the direction and control of the controller 110. FIG. 1 shows the wings 25-28 positioned for forward flight in a configuration referred to herein as “forward-flight configuration” in which the wings 25-28 are positioned to generate sufficient aerodynamic lift for counteracting the weight of the aircraft 20 as may be desired for forward flight. In such forward-flight configuration, the wings 25-28 are generally positioned close to horizontal, as shown by FIG. 1, so that the chord of each wing 25-28 has an angle of attack for efficiently generating lift for forward flight. The lift generated by the wings 25-28 is generally sufficient for maintaining flight as may be desired.

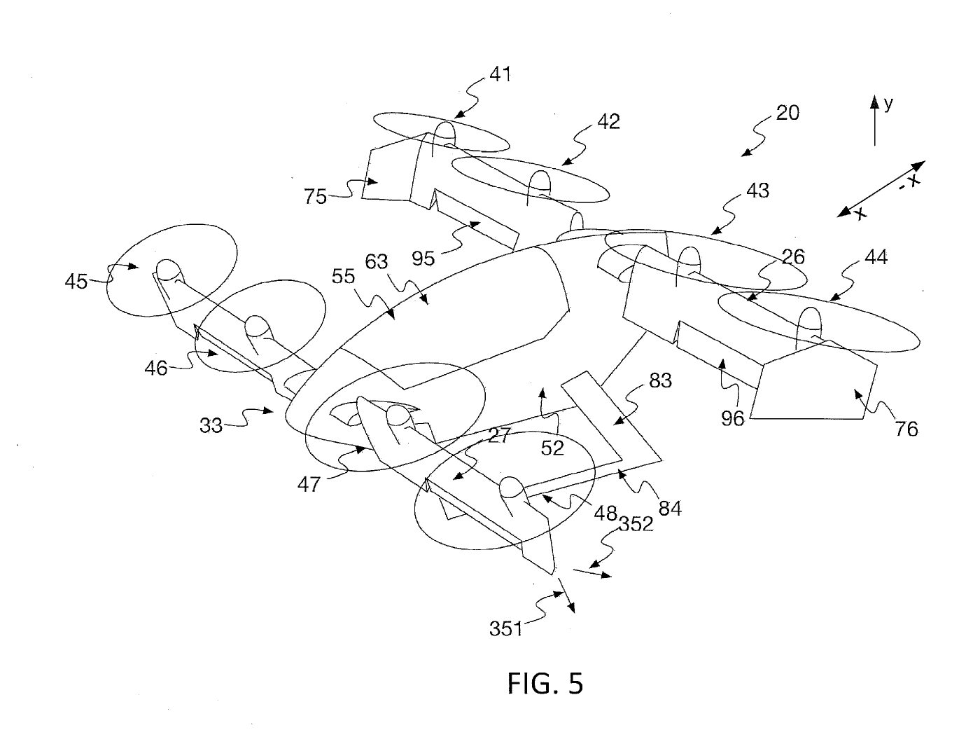

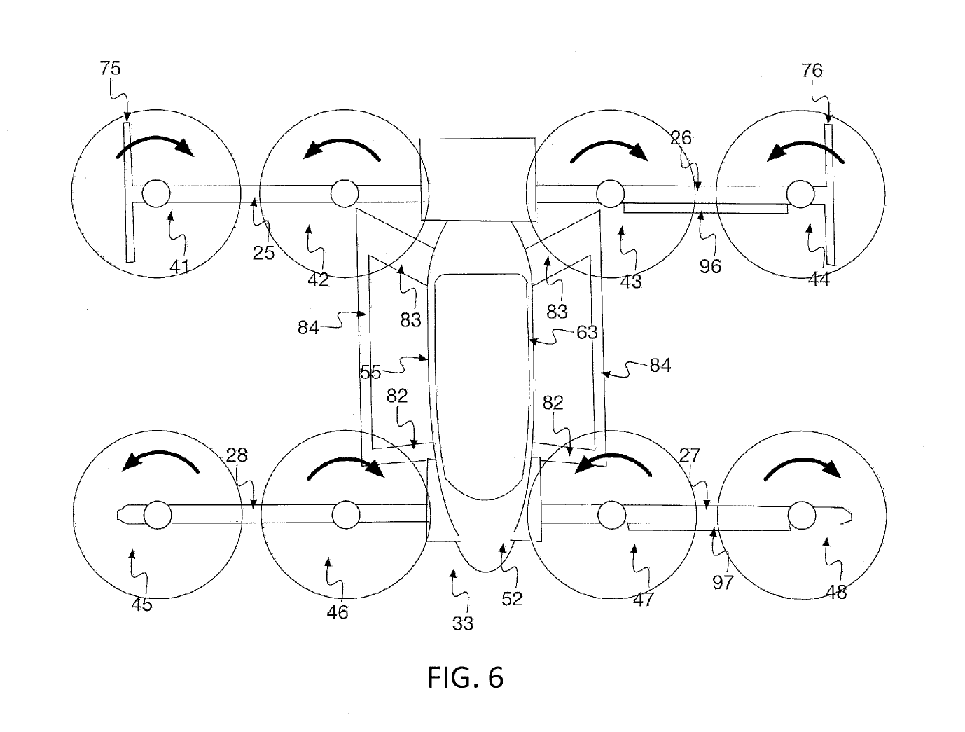

When desired, such as when the aircraft 20 nears its destination, the wings 25-28 may be rotated in order to transition the configuration of the wings 25-28 from the forward-flight configuration shown by FIG. 1 to a configuration, referred to herein as “hover configuration,” conducive for performing vertical takeoffs and landings. In the hover configuration, the wings 25-28 are positioned such that the thrust generated by the propellers 41-48 is sufficient for counteracting the weight of the aircraft 20 as may be desired for vertical flight. In such hover configuration, the wings 25-28 are positioned close to vertical, as shown by FIG. 5, so that thrust from the propellers 41-48 is generally directed upward to counteract the weight of the aircraft 20 in order to achieve the desired vertical speed, although the thrust may have a small offset from vertical for controllability, as described in more detail in commonly-assigned PCT Patent Application No. PCT/US2017/018135, entitled “Vertical Takeoff and Landing Aircraft with Tilted-Wing Configurations” and filed on even date herewith, which is incorporated herein by reference. A top view of the aircraft 20 in the hover configuration with the wings 25-28 rotated such that the thrust from the propellers is substantially vertical is shown by FIG. 6.

Note that the direction of rotation of the propeller blades, referred to hereafter as “blade direction,” may be selected based on various factors, including controllability while the aircraft 20 is in the hover configuration. In some embodiments, the blade directions of the outer propellers 41, 45 on one side of the fuselage 33 mirror the blade directions of the outer propellers 44, 48 on the other side of the fuselage 33. That is, the outer propeller 41 corresponds to the outer propeller 48 and has the same blade direction. Further, the outer propeller 44 corresponds to the outer propeller 45 and has the same blade direction. Also, the blade direction of the corresponding outer propellers 44, 45 is opposite to the blade direction of the corresponding outer propellers 41, 48. Thus, the outer propellers 41, 44, 45, 48 form a mirrored quad arrangement of propellers having a pair of diagonally-opposed propellers 41, 48 that rotate their blades in the same direction and a pair of diagonally-opposed propellers 44, 45 that rotate their blades in the same direction.

In the exemplary embodiment shown by FIG. 5, the outer propellers 41, 48 are selected for a clockwise blade direction (when viewed from the front of the aircraft 20), and the outer propellers 44, 45 are selected for a counter-clockwise blade direction (when viewed from the front of the aircraft 20) so as to realize the wingtip-mounting benefits previously described above for propellers 45, 48. However, such selection may be reversed, if desired so that blades of propellers 41, 48 rotate counter-clockwise and blades of propellers 44, 45 rotate clockwise.

In addition, the blade directions of the inner propellers 42, 46 on one side of the fuselage 33 mirror the blade directions of the inner propellers 43, 47 on the other side of the fuselage 33. That is, the inner propeller 42 corresponds to the inner propeller 47 and has the same blade direction. Further, the inner propeller 43 corresponds to the inner propeller 46 and has the same blade direction. Also, the blade direction of the corresponding inner propellers 43, 46 is opposite to the blade direction of the corresponding inner propellers 42, 47. Thus, the inner propellers 42, 43, 46, 47 form a mirrored quad arrangement of propellers having a pair of diagonally-opposed propellers 42, 47 that rotate their blades in the same direction and a pair of diagonally-opposed propellers 43, 46 that rotate their blades in the same direction. In other embodiments, the aircraft 20 may have any number of quad arrangements of propellers, and it is unnecessary for the propellers 41-48 to be positioned in the mirrored quad arrangements described herein.

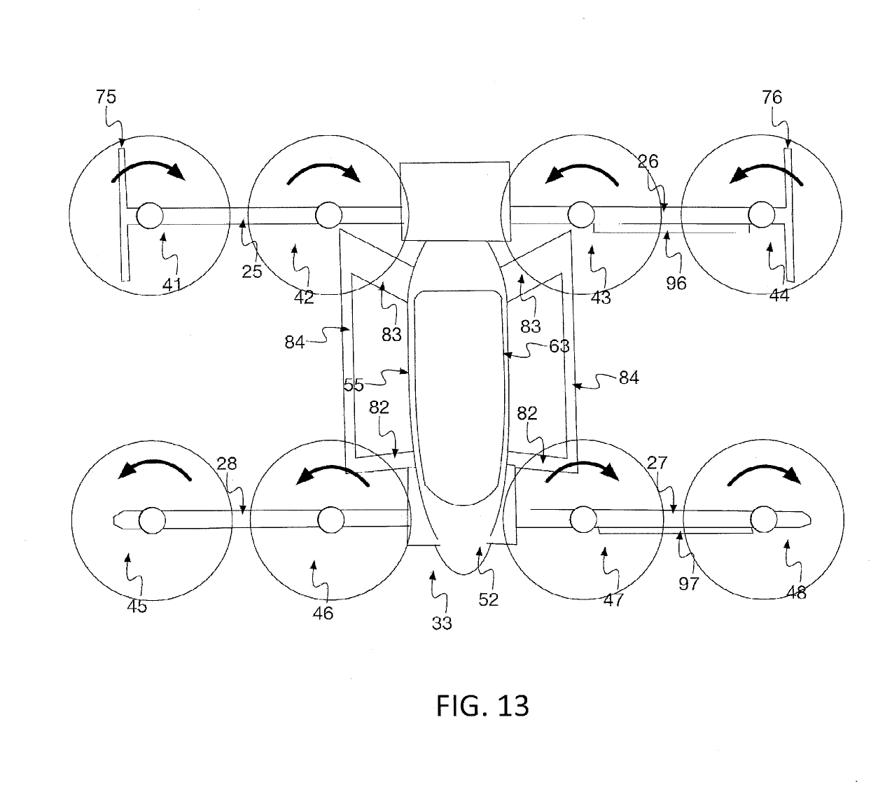

In the exemplary embodiment shown by FIG. 5, the corresponding inner propellers 42, 47 are selected for a counter-clockwise blade direction (when viewed from the front of the aircraft 20), and the corresponding inner propellers 43, 46 are selected for a clockwise blade direction (when viewed from the front of the aircraft 20). This selection has the advantage of ensuring that portions of the rear wings 25, 26 on the inboard side of propellers 42, 43 stall due to the upwash from propellers 42, 43 before the portions of the wings 25, 26 on the outboard side of the propellers 42, 43. This helps to keep the airflow attached to the surface of the wings 25, 26 where the flight control surfaces 95, 96 are located as angle of attack increases, thereby helping to keep the flight control surfaces 95, 96 functional for controlling the aircraft 20 as a stall is approached. However, such selection may be reversed, if desired, so that blades of propellers 42, 47 rotate clockwise and blades of propellers 43, 46 rotate counter-clockwise, as shown by FIG. 13. Yet other blade direction combinations are possible in other embodiments.

By mirroring the blade directions in each quad arrangement, as described above, certain controllability benefits can be realized. For example, corresponding propellers (e.g., a pair of diagonally-opposed propellers within a mirrored quad arrangement) may generate moments that tend to counteract or cancel so that the aircraft 20 may be trimmed as desired. The blade speeds of the propellers 41-48 can be selectively controlled to achieve desired roll, pitch, and yaw moments. As an example, it is possible to design the placement and configuration of corresponding propellers (e.g., positioning the corresponding propellers about the same distance from the aircraft's center of gravity) such that their pitch and roll moments cancel when their blades rotate at certain speeds (e.g., at about the same speed). In such case, the blade speeds of the corresponding propellers can be changed (i.e., increased or decreased) at about the same rate or otherwise for the purposes of controlling yaw, as will be described in more detail below, without causing roll and pitch moments that result in displacement of the aircraft 20 about the roll axis and the pitch axis, respectively. By controlling all of the propellers 41-48 so that their roll and pitch moments cancel, the controller 110 can vary the speeds of at least some of the propellers to produce desired yawing moments without causing displacement of the aircraft 20 about the roll axis and the pitch axis. Similarly, desired roll and pitch movement may be induced by differentially changing the blade speeds of propellers 41-48. In other embodiments, other techniques may be used to control roll, pitch, and yaw moments.

In the event of a failure of any propeller 41-48, the blade speeds of the other propellers that remain operational can be adjusted in order to accommodate for the failed propeller while maintaining controllability. In some embodiments, the controller 110 stores predefined data, referred to hereafter as “thrust ratio data,” that indicates desired thrusts (e.g., optimal thrust ratios) to be provided by the propellers 41-48 for certain operating conditions (such as desired roll, pitch, and yaw moments) and propeller operational states (e.g., which propellers 41-48 are operational). Based on this thrust ratio data, the controller 110 is configured to control the blade speeds of the propellers 41-48, depending on which propellers 41-48 are currently operational, to achieve optimal thrust ratios in an effort to reduce the total thrust provided by the propellers 41-48 and, hence, the total power consumed by the propellers 41-48 while achieving the desired aircraft movement. As an example, for hover flight, the thrust ratios that achieve the maximum yawing moment for a given amount of total thrust may be determined.

In some embodiments, the thrust ratio data is in the form of matrices or other data structures that are respectively associated with certain operational states of the propellers 41-48. For example, one matrix may be used for a state in which all of the propellers 41-48 are operational, another matrix may be used for a state in which one propeller (e.g., propeller 42) has failed, and yet another matrix may be used for a state in which another propeller (e.g., propeller 43) as has failed. There may be at least one matrix associated with each possible propeller operational state.

Each matrix may be defined based on tests performed for the propeller operational state with which it is associated in order to derive a set of expressions (e.g., coefficients) that can be used by the controller 110 to determine the desired thrusts for such operational state. As an example, for a given operational state (such as a failure of a particular propeller 41-48), tests may be performed to determine the optimal ratio of thrusts for the operational propellers in order to keep the aircraft 20 trimmed. A matrix associated with such operational state may be defined such that, when values indicative of the desired flight parameters (e.g., a value indicative of the desired amount of yaw moment, a value indicative of the desired amount of pitch moment, a value indicative of the desired amount of roll moment, and a value indicative of the desired amount of total thrust) are mathematically combined with the matrix, the result provides at least one value indicative of the optimal thrust for each operational propeller in order to achieve the desired flight parameters. Thus, after determining the desired flight parameters for the aircraft 20 during operation, the controller 110 may determine the current propeller operational state of the aircraft 20 and then analyze the thrust ratio data based on such operational state and one or more of the flight parameters to determine a value for controlling at least one of the propellers 41-48. As an example, the controller 110 may be configured to combine values indicative of the desired flight parameters with the matrix that is associated with the current propeller operational state of the aircraft 20 in order to determine at least one value for controlling each operational propeller 41-48. Note that the motor controllers 221-228 (FIG. 3) or sensors (not specifically shown) for monitoring the operational states of the propellers 41-48 may inform the controller 110 about which propellers 41-48 are currently operational.

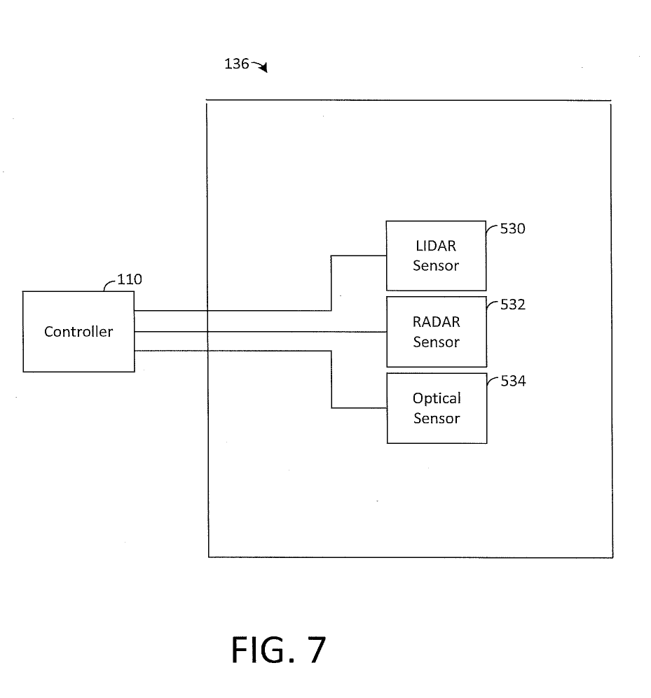

As described above, during flight (whether in the forward-flight configuration or the hover configuration), the controller 110 may be configured to detect collision threats using the collision avoidance sensors 136 and to control the aircraft 20 to avoid such detected threats. FIG. 7 depicts exemplary collision avoidance sensors 136 that may be used by the controller 110 for this purpose in accordance with some embodiments of the present disclosure. The exemplary collision avoidance sensors 136 of FIG. 7 include a Light Detection And Ranging (LIDAR) sensor 530, a Radio Detection And Ranging (radar) sensor 532, and an optical sensor 534. Although the exemplary sensors 136 shown by FIG. 7 include three sensors of different types, in other embodiments, the collision avoidance sensors 136 may include any number, combination, or types of sensors in order to achieve the collision-avoidance functionality described herein. As a mere example, such sensors may include components and systems for GPS sensing, satellite navigation (e.g., automatic dependent surveillance broadcast or ADS-B), vibration monitoring, differential pressure sensing, or other sensors.

The LIDAR sensor 530 is configured to image objects based on reflected pulses of laser, ultraviolet, invisible, or near-infrared light. The LIDAR sensor 530 is configured to transmit pulses of light for illuminating a surface of an object (e.g., terrain, aircraft, or obstacles), detect returns of the light reflecting from the object's surface to define an image of the object, and provide data indicative of the image to the controller 110. The controller 110 may use data from the LIDAR sensor 530 to detect objects close in proximity to the aircraft 20 (e.g., within about 200 m or less). In other embodiments, the LIDAR sensor 530 may be used to detect objects within other ranges, and it is possible that other types of sensors may be used to detect objects within a short range in addition to or instead of the LIDAR sensor 530.

The radar sensor 532 is configured to transmit pulses of radio waves or microwaves and detect returns of the pulses that reflect from objects in order to sense the presence of the objects. When the radar sensor 532 detects an object, the sensor 532 provides data indicative of a location of the object (e.g., direction and distance) to the controller 110. In some embodiments, the controller 110 may use data from the radar sensor 532 to detect objects further from the aircraft 20 (e.g., within about 1-2 miles) than may be detected using other individual sensors 136, such as the LIDAR sensor 530.

In some embodiments, the optical sensor 534 may comprise at least one conventional camera, such as a video camera or other type of camera, that is configured to capture images of a scene. Such camera has at least one lens that is positioned to receive light from a region, such as the airspace through which the aircraft 20 is flying, and converts light received through the lens to digital data for analysis by the controller 110. The controller 110 may be configured to employ an algorithm for detecting moving objects relative to a background in order to sense other aircraft that may be flying within a vicinity of the aircraft 20. In this regard, the controller 110 may analyze and compare multiple frames of captured images in order to identify moving objects. Specifically, the controller 110 may identify objects relative to a background and compare an identified object in at least one frame to the object in at least one other frame to determine an extent to which the object has moved. A moving object may be another aircraft that is a collision threat to the aircraft 20. Based on the determined movement, the controller 110 may estimate the direction and speed of the object.

In some embodiments, the radar sensor 532 and the optical sensor 534 may be used to detect objects that pose threats to the aircraft 20 in forward flight. Radar sensors 532 generally have a relatively long and wide range that make them particularly suitable for sensing objects in forward flight. In the hover configuration for takeoffs and landings, the LIDAR sensor 530 may be used for sense-and-avoid functions, such as detecting objects that pose threats to the aircraft 20. The LIDAR sensor 530 may also be used to map terrain in order to find a suitable location for landing. In this regard, the controller 110 may use a map provided by the LIDAR sensor 530 in order to find and select for landing a relatively flat area that is substantially free of obstacles that might pose a threat to the aircraft 20. If desired, the LIDAR sensor 530 may be mounted on a mechanical gimbal that is arranged to move the LIDAR sensor 530 in a “sweeping” motion in order to increase the spatial resolution of the LIDAR sensor 530.

When the controller 110 detects a moving object, the controller 110 may assess whether the object is a collision threat for which it would be desirable for the controller 110 to deviate the aircraft 20 from its current path. In this regard, the controller 110 may estimate the path of the moving object based on its location, direction and speed of movement and, based on such path and the current route of the aircraft 20, determine whether the moving object and the aircraft 20 will likely come within a threshold distance of each other. If so, the controller 110 may be configured to deviate the aircraft 20 from its current path by calculating a new path that ensures the aircraft 20 and the object will remain at least a threshold distance from each other. The controller 110 may then control the aircraft 20 to fly along the new path. An exemplary collision avoidance algorithm will be described in more detail below.

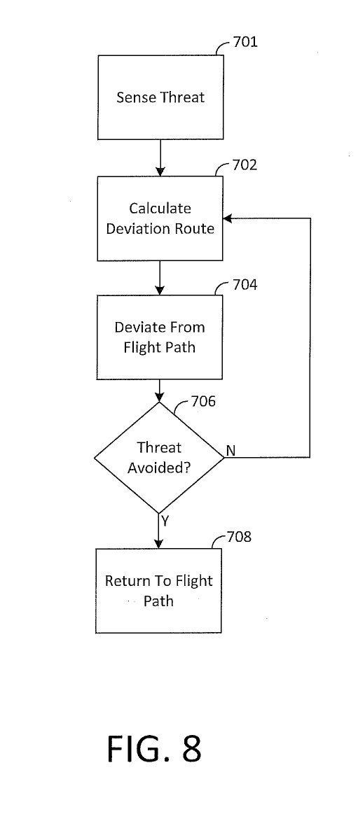

FIG. 8 depicts steps for collision avoidance in accordance with some embodiments of the present disclosure. At step 701, the controller 110 senses a threat based on data from the collision avoidance sensors 136. Threats sensed by the controller 110 may include objects (both stationary and moving) that are or likely will be within a threshold distance of the current flight path of the aircraft 20, objects within a buffer radius surrounding aircraft 20 during flight, takeoff, or landing, or other objects that present a sufficient risk to safe operation of the aircraft 20 for which deviation from the flight path of the aircraft 20 is desirable. In some embodiments, the controller 110 may establish the existence of a threat by applying an algorithm to data from sensors 136 to derive a characteristic indicative of the risk posed to safe operation of the aircraft 20, such as the distance that a detected object is or likely will be from the aircraft 20 based on (1) the aircraft's current route and (2) the location and/or velocity of the detected object. The controller 110 may compare the characteristic to a threshold and determine the existence of a threat based on the comparison. As an example, based on whether the threshold is exceeded, the controller 110 may determine that a threat has been sensed and may take action to avoid the threat.

After the controller 110 determines that a threat has been sensed, processing may continue to step 702. At step 702, the controller 110 may calculate a deviation route based on a determination that a threat has been sensed. In some embodiments, the controller 110 may calculate a deviation route for the aircraft 20 based on data received from the sensors 136 that will enable it to avoid the threat. The controller 110 may calculate the deviation route using any suitable information available to it in order to enable the aircraft 20 to avoid the sensed threat. For example, the controller 110 may calculate the deviation route based on relative positions of the threat and aircraft 20, relative velocities, trajectories, sizes, and other characteristics of the threat and aircraft 20, and atmospheric conditions (e.g., weather) in the region. In some embodiments, the controller 110 may take additional action while calculating a deviation route, such as providing warnings (e.g., to a passenger of the aircraft 20 or others associated with a threat, for example, oncoming aircraft).

Note that the controller 110 may continue tracking a threat over a period of time and may determine that it is desirable to recalculate a deviation route for the aircraft 20 based on a change detected to the threat. For example, the controller 110 may evaluate whether a recalculation of the deviation route is desirable, if a trajectory or position of an object presenting a threat to the aircraft 20 changes or if the controller 110 loses track of the object (i.e., is no longer able to detect the object). As an example, if the controller 110 loses track of the object, the controller 110 may calculate a new deviation route that provides a greater margin of safety (e.g., separation distance) with respect to the estimated path or location of the threat. In other embodiments, the controller 110 may use any suitable data to calculate a deviation route and determine whether the route is to be recalculated based on a change to the threat sensed. After the deviation route has been calculated, processing may continue to step 704 at which point the controller 110 controls the aircraft 20 to fly along the deviation route.

At step 706, the controller 110 may determine whether the aircraft 20 has avoided the threat sensed at step 701, for example, based on data from the sensors 136. In some embodiments, the controller 110 may evaluate whether the threat has been avoided by applying the algorithm at step 701 to subsequent data from sensors 136, deriving a characteristic indicative of the risk posed to safe operation of the aircraft 20, and comparing the characteristic to a threshold. If the characteristic indicates that the threat continues to exist, the controller 110 may return to step 702 and resume processing from step 702. If the characteristic indicates that the threat no longer exists, then the controller 110 may determine that the threat has been successfully avoided, and processing may continue to step 708.

At step 708, the controller 110 may return the aircraft 20 to the original flight path for its destination. In some embodiments, the controller 110 may calculate a new flight path to its destination based on its current location after deviation, or the deviation route may define a path all of the way to the destination. Regardless of the manner in which a flight path to the destination is calculated or otherwise determined, the controller 110 controls the aircraft 20 to fly to its destination and repeats the process shown by FIG. 8 if a new threat is detected along its route.

In some embodiments, the controller 110 may sense a threat by communicating aircraft positions and velocities with other aircraft. In this regard, the various aircraft may be designed to automatically communicate with one another in order to discover each other's positions and routes in order to assist with collision avoidance. As an example, the controller 110 may broadcast the position and velocity of the aircraft 20, using a two-way transponder (e.g., using ADS-B) or other communication equipment. The controller 110 may receive a response to its communication (e.g., from air traffic control or an aircraft capable of cooperating in collision avoidance operations) indicating the position and velocity of other nearby aircraft. The controller 110 may then determine that a threat exists based on the response. For example, the controller 110 may determine that a threat exists if a response to a communication broadcasting the flight path (e.g., position and velocity) of the aircraft 20 is indicative of a presence of another vehicle or obstacle within a distance of the flight path that poses a risk to safe travel for the aircraft 20 along the flight path. In this regard, once the controller 110 determines the location and velocity of another aircraft through communication with such other aircraft or traffic control, the controller 110 may assess the threat and, if appropriate, deviate from its current route using the techniques described above for avoiding aircraft detected by the collision and avoidance sensors 136.

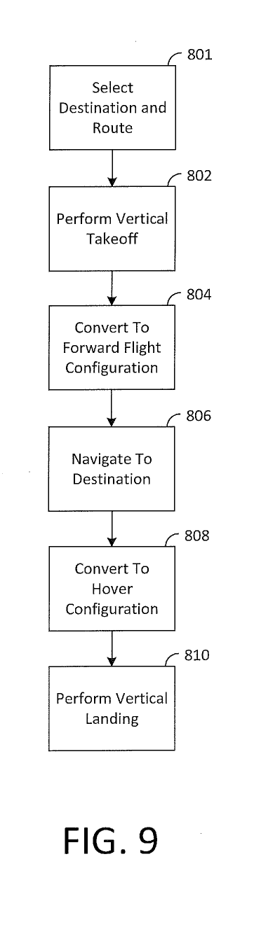

As described above, the controller 110 may be configured to aviate and navigate the aircraft 20 without the assistance of a human pilot. FIG. 9 depicts steps for self-piloted flight by the controller 110 in accordance with some embodiments of the present disclosure.

At step 801, a route for the aircraft 20 is selected. The route may be selected based on one or more destinations and based on any suitable conditions for selecting a route for aerial travel (e.g., atmospheric conditions, aircraft characteristics, distance to destination, time of day, etc.). Note that route selection may be based on input from a user, such as a passenger or cargo transportation customer.

As an example, the flight data 210 used by the controller 110 may include a predefined list of destinations and, for each destination, at least one predefined route for flying to the destination. A person using the user interface 139 (FIG. 3) or other interface (e.g., a mobile device communicating with the controller 110 via the wireless communication interface 142 depicted by FIG. 3) may communicate with the controller 110 to retrieve and view the list of destinations and then provide an input for selecting a destination. In response to a destination selection, the controller 110 may automatically select a predefined route indicated by the flight data 210. Alternatively, data indicative of the predefined routes associated with the selected destination may be displayed to the user, and the user may provide an input for selecting one of the displayed routes. If a route to the destination is not predefined, the controller 110 may calculate one or more routes and then either select one of the calculated routes or display the calculated routes for selection by the user.

Note that it is unnecessary for a predefined destination to be selected. As an example, the flight data 210 may define a map that may be displayed to a user, and the user may be permitted to select a location on the map as the aircraft's destination. If the selected destination is not associated with a predefined route, the controller 110 may calculate a route to the destination, as described above. Once a destination and route have been selected, processing may continue to step 802.

At step 802, the controller 110 may control the aircraft 20 in order to perform a vertical takeoff. In some embodiments, the aircraft 20 may begin vertical takeoff operations in the hover configuration, enabling the aircraft 20 to achieve a substantially vertical flight path at takeoff. Using the flight sensors 133, the controller 110 may provide control inputs for controlling the propellers 41-48, wings 25-28, and flight control surfaces 95-98 in order to orient and control movement of the aircraft 20 in a desired manner. In addition, using the collision avoidance sensors 136 and more specifically the LIDAR sensor 530, which can accurately detect objects within a short distance of the aircraft 20, the controller 110 controls the aircraft 20 during takeoff to ensure that it does not collide with a detected object. After the aircraft 20 has performed vertical takeoff, processing may continue to step 804.

At step 804, the aircraft 20 may convert to a forward-flight configuration, as described above. A smooth transition from the hover configuration to the forward-flight configuration may occur based on guidance from the controller 110. In this regard, the controller 110 may determine that the aircraft 20 may safely perform conversion to the forward-flight configuration based on various flight characteristics determined by controller 110 (e.g., aircraft altitude, velocity, attitude, etc.), as well as an assessment and determination that conversion to the forward-flight configuration may be done safely (e.g., a determination that no collision threats are detected in the flight path of the aircraft 20). After the aircraft 20 converts to forward-flight configuration, processing may continue to step 806.

At step 806, the controller 110 may control the aircraft 20 in order to navigate it to the selected destination according to the selected route. As the aircraft 20 travels, the controller 110 may use the collision avoidance sensors 136 to sense and avoid threats along its route, according to the techniques described herein. Note that navigation during flight may occur with regard to any suitable information available to controller 110, such as data from GPS sensing, ADS-B or other satellite navigation, sensors 136, or other information. In some embodiments, the aircraft 20 may include components or circuitry suitable for navigation of the aircraft 20 via remote control. In this regard, control of the aircraft 20 may be transferred as desired, for example, in the event of a system failure on the aircraft 20 or other situation in which aircraft 20 may not retain functionality of components necessary to achieve safe self-piloted flight. In some embodiments, the aircraft 20 may comprise components and circuitry sufficient to permit a passenger to control operation of aircraft 20, for example, in the event of an emergency. Once the aircraft 20 arrives at a point close its destination, processing may continue to step 808.

At step 808, the controller 110 may control the aircraft 20 in order to convert it from the forward-flight configuration to the hover configuration for performing a vertical landing. In this regard, the controller 110 may transition the aircraft 20 to the hover configuration by rotating the wings 25-28 upward such that the thrust from the propellers 41-48 is substantially directed in a vertical direction, as generally shown by FIG. 5. Such hover configuration permits the aircraft 20 to achieve substantially vertical flight in an efficient manner. After conversion of aircraft 20 from the forward-flight configuration to the hover configuration, processing may continue to step 810.

At step 810, the controller 110 controls the aircraft 20 to perform a vertical landing while in the hover configuration. While in the hover configuration, the thrust from the propellers 41-48 counteracts the weight of the aircraft 20 in order to achieve a desired vertical speed. In addition, lateral movements may be effectuated by slightly tilting the wings 25-28 such that there is a small angular offset from vertical for the propeller thrust vectors, resulting in a horizontal thrust-vector component sufficient for moving the aircraft 25 horizontally as may be desired. Yaw control may also be achieved through wing tilt, as well as actuation of the flight control surfaces 95-98 and manipulation of the blade speeds of the propellers 41-48.

In some embodiments, a plurality of aircraft 20 operating under common control (hereafter referred to as a “fleet”) may perform self-piloted flight operations in coordination with one another and other aircraft for various commercial and other purposes. In an exemplary embodiment, the fleet may include a substantial number of aircraft 20 (e.g., between 100,000 and 5 million active vehicles), and may operate in coordination with other aircraft (e.g., emergency, military, or other aircraft). In an embodiment, control of operations of the fleet may be centralized and may provide full control capabilities of operation of each aircraft 20 within the fleet. Thus, each aircraft 20 may operate efficiently with regard to other aircraft 20 within the fleet and other cooperating aircraft based on communication with other aircraft 20, cooperating aircraft, or a centralized air traffic management network, as described below.

The fleet may perform a variety of commercial services, including transportation of passengers and cargo. As an example, aircraft 20 of the fleet may be configured for transportation of oil and gas produced at remote wells, rigs or refineries in substantially less time than may be achieved using ships or ground-based transportation and with a substantial reduction in cost with regard to existing aerial transportation (e.g., using conventional helicopters). In other examples, aircraft 20 of the fleet may be configured for package delivery (e.g., same-day delivery of medical supplies, perishable items or other time-sensitive packages) or for the delivery of other goods. In some embodiments, aircraft 20 of the fleet may be configured for transportation of passengers, including patients in need of critical, time-sensitive or life-saving medical care (e.g., MedEvac flights or organ donation and organ transplant flights) or doctors whose assistance may be required in a remote location without timely or practical access to physician care. In this regard, the fleet may bypass otherwise lengthy travel times using ground-based vehicles on congested or impassible routes. Moreover, in some embodiments, commuters may realize substantial savings in travel times and costs with regard to conventional ground travel. As an example, a substantial savings may accumulate if, for example, a commuter may travel in an aircraft 20 of the fleet twice daily. In this regard, a commuter may avoid costs associated with navigating congested, high traffic-volume travel routes on a consistent basis.

The airspace through which the aircraft 20 flies may be controlled through the use of an air traffic management protocol. In this regard, the airspace may be divided into blocks of airspace, and the blocks of airspace may be selectively assigned to aircraft 20 at different times in order to avoid collisions. As an example, at any given instant, a block of airspace may be assigned to a single aircraft for a finite time period so that such single aircraft is the only aircraft permitted to be within the assigned airspace during the time period. Control of the assigned blocks of airspace may be centralized where each aircraft 20 communicates with a central server for airspace assignment. The airspace assignment may be performed manually, such as by air traffic control personnel, or may be performed automatically by the centralized server or otherwise.

In some embodiments, a large number of aircraft 20 (e.g., a fleet) may communicate with each other to form a network, and portions of the air traffic management functions may be offloaded to the network. As an example, once the controller 110 has selected a route for the aircraft 20, the controller 110 may wireless transmit messages requesting blocks of airspace for time periods in which the controller 110 expects to fly according to its flight plan. Each request may include an airspace identifier that identifies the block of airspace and a time identifier that identifies the time period that is requested for the identified block of airspace. Other aircraft with previously-approved flight plans may assess whether a requested block of airspace by the controller 110 conflicts with their flight plans. Such a conflict may occur when the controller 110 has requested a block of airspace during a time period that is already assigned to another aircraft according to a previously-approved flight plan. If such a conflict exists, the aircraft with the previously-approved flight plan associated with the conflict responds to the controller's request with a reply indicative of the conflict. In response, the controller 110 may select a different route or create a new flight plan with different flight times or routes in an effort to find a flight plan that would not be in conflict with other previously-approved flight plans.

If the controller 110, however, does not receive a reply indicating a conflict for any of the requests associated with its current flight plan, then the current flight plan may be deemed to be “approved” by the network. The controller 110 may then control the aircraft 20 to fly through the airspace according to the flight plan. Once a flight plan is approved, the controller 110 may also monitor the communications from other aircraft to determine whether a request for a block of airspace conflicts with the controller's approved flight plan. If so, the controller 110 may reply to the request in order to inform the other aircraft of the conflict, as described above.

Note that requests for blocks of airspace may be assigned priorities, which are used to resolve conflicts for airspace in a prioritized manner. As an example, emergency aircraft used by first responders may be assigned a higher priority than non-emergency aircraft. Each request for airspace assignment may include a value indicative of the requesting aircraft's priority. If an aircraft of a lower priority determines that the request is a conflict with its flight plan, such other aircraft may modify its flight plan in order to avoid the conflict according to the techniques described above even if its flight plan has been previously approved.

The airframe of the aircraft 20 (e.g., fuselage 33, wings 25-28, landing skids 81, etc.) preferably comprises lightweight materials in an effort to enhance performance and reduce power burdens on the electrical power system 163, yet the materials should have sufficient mechanical integrity to withstand the forces and stresses incurred over the life of the aircraft 20. In some embodiments, composite materials are used for the airframe. As an example, suitable composite materials may be produced using methods such as High Pressure Resin Transfer Molding (HPRTM). Such methods may yield lower waste production rates while lending themselves to high automation, reducing production costs. An exemplary process for manufacturing composite materials for the aircraft 20 is described in more detail below.

In some embodiments, aircraft 20 may comprise various components and systems for enhancement of operational safety. As an example, propellers 41-48 of the aircraft 20 may pose a risk of serious injury to a human passenger during ingress or egress of the aircraft 20 in the absence of proper safety mechanisms. In some embodiments, each of propellers 41-48 may include a propeller shroud (not shown) for shielding the propellers 41-48 from making contact with objects, particularly during operation (e.g., contacting a human or object that may move into the rotational radius of the propellers 41-48). In this regard, damage (e.g., to a human, object, or propellers 41-48) caused by contact with the blades of the propellers 41-48 during operation may be avoided. In addition, in some embodiments, the tips of the propeller blades may be frangible. In this regard, the blade tips of the propellers 41-48 may be designed to shatter or otherwise break upon impact, which may dissipate energy and minimize injury to a passenger or a bystander, for example, in the event of contact by the propellers 41-48 with terrain or other object (e.g., during a hard landing of the aircraft 20).

In some embodiments, operational safety enhancements may include components or systems for evacuation and recovery of passengers or cargo in the event of failure a system of the aircraft 20 necessitating such evacuation. As an example, an event (such as an emergency scenario) may require evacuation of the aircraft 20 to prevent damage or injury to passengers or cargo. The aircraft 20 may include an evacuation system, such as a Ballistic Recovery System (BRS) or other system for safe evacuation. Note that the evacuation system may be initiated remotely or by a passenger of the aircraft 20, and an initiation may be postponed until it is determined (i.e., by the controller 110 of aircraft 20 or otherwise) that the aircraft 20 has reached a location (e.g., suitable terrain) where evacuation may be performed safely. In some embodiments, the controller 110 may identify alternate landing locations and divert its flight path to attempt to land safely at a suitable location. In some cases, the diversion may be made in response to a determination of the occurrence of a non-critical failure event (e.g., lost radio link, degraded GPS sensing, power loss or battery failure). Moreover, the location and type of landing performed may be based on the type of failure detected. As an example, for some failures, the controller 110 may divert the aircraft 20 to the nearest suitable location for an evacuation and then perform an evacuation (e.g., via BRS activation or otherwise), whereas for other less severe failures, the controller 110 may divert the aircraft 20 to a suitable location for performing a vertical landing.

As noted above in reference to FIG. 1, in some embodiments, aircraft 20 may comprise a removable, modular compartment configured for transportation of a specific payload, such as passenger module 55, which may be configured for transporting a human passenger, or a cargo module, which may be configured for transporting cargo of various types. As noted with regard to FIG. 1, passenger module 55 may comprise a floor, at least one seat (not depicted), e.g., a lightweight, impact-absorbing seat, and a transparent canopy 63. Passenger module 55 may comprise other components for promoting passenger comfort, such as cabin illumination devices, environmental controls, and a firewall/smokewall in other embodiments. In some embodiments, passenger module 55 also may comprise user interface 139 (FIG. 3), which may include a touch screen for selecting inputs and displaying outputs. In addition, the modular compartment and frame 52 may comprise any necessary components (e.g., hardware, electronics, or other components) for coupling the modular compartment (e.g., passenger module 55) to the frame 52 for safe transportation during flight.

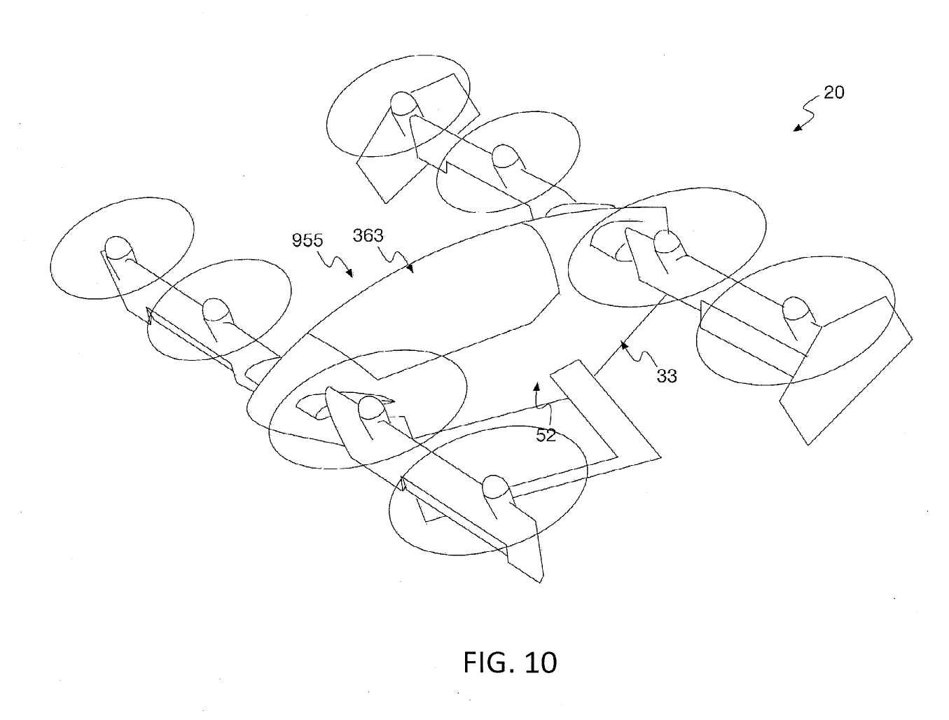

FIG. 10 depicts an exemplary aircraft 20 configured for cargo transportation in accordance with some embodiments of the present disclosure. In some embodiments, the modular compartment may be implemented as a cargo module 955, and may be configured as desired for transporting cargo (i.e., a payload other than a human passenger). In an embodiment, aircraft 20 may be converted from a passenger-transportation configuration to a cargo-transportation configuration by lifting and removing passenger module 55 from aircraft 20 and replacing it with cargo module 955, as shown by FIG. 10. In some embodiments, the cargo module 955 may comprise a floor, an interior space for holding cargo, and an opaque canopy 363, although other types of canopies and structures are possible. The cargo module 955 may comprise any necessary components for securing cargo contained within cargo module 955 for safe transportation aboard aircraft 20, for example, using restraints, bracing, or other components. In addition, cargo module 955 and frame 52 may comprise any necessary components (e.g., hardware, electronics, or other components) for coupling the cargo module 955 to the frame 52 for safe transportation during flight. Note that a cargo module 955 may comprise substantially the same outer dimensions and shape as passenger module 55. In this regard, the shape and dimensions of the surfaces of aircraft 20 may remain consistent, and characteristics of airflow across surfaces of the aircraft 20 (e.g., fuselage 33) may remain consistent independent of whether the modular compartment of aircraft 20 is configured for transportation of passengers (e.g., passenger module 55) or cargo (e.g., cargo module 955).

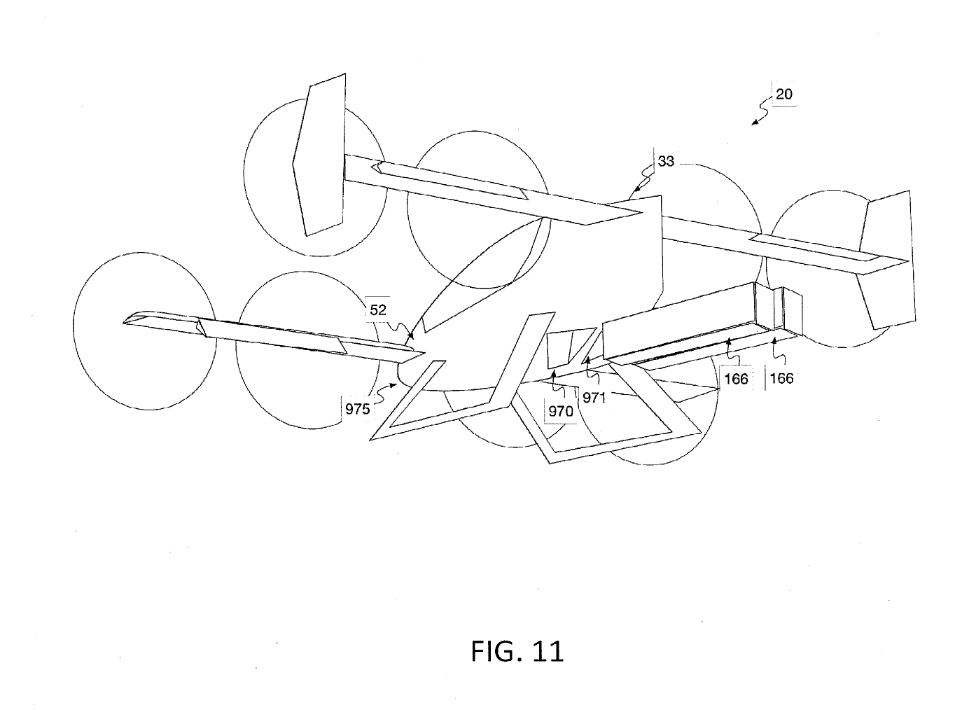

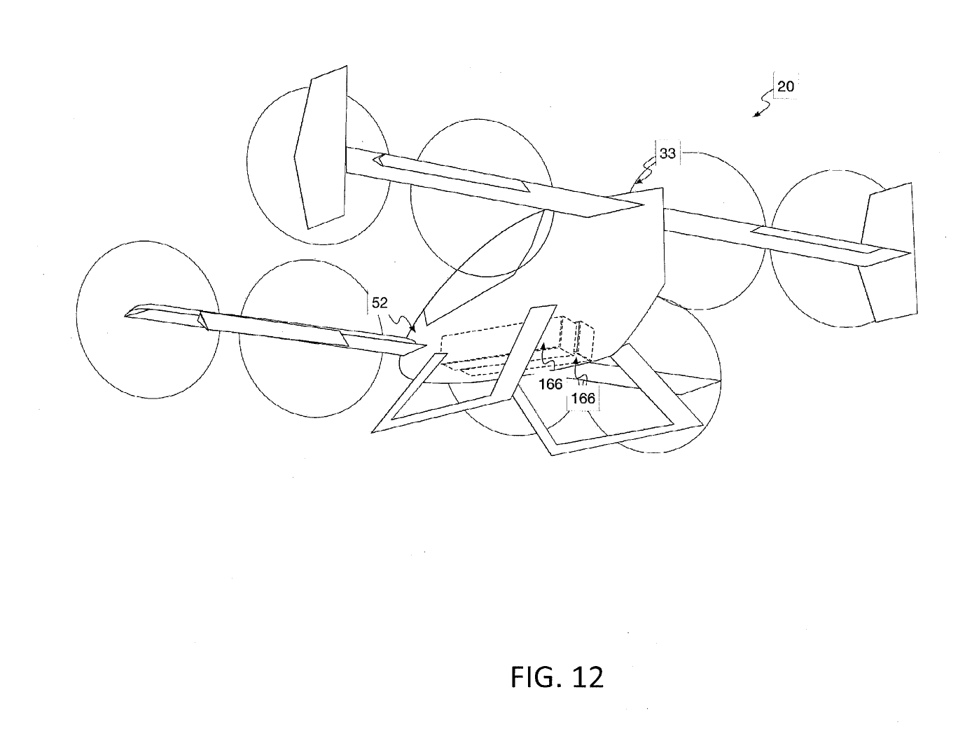

FIG. 11 depicts a rear view of an aircraft 20 in accordance with some embodiments of the present disclosure. FIG. 11 shows the batteries removed from the aircraft 20 for illustrative purposes, and FIG. 12 shows the batteries 166 positioned in the fuselage 33. In the exemplary embodiment shown by FIG. 11, a plurality of batteries 166 (FIG. 3) for powering various components of aircraft 20 may be stored in one or more battery compartments 970 within the frame 52 beneath the fuselage 33 (FIG. 1). The batteries 166 may be loaded into battery compartments 970 and coupled to an electrical interface (not depicted) for providing electrical power from the batteries 166 to the various components and systems of the aircraft 20. In this regard, for each compartment 970, the frame 52 may have a port (e.g., an air intake or air outlet) through which a battery 972 may be loaded into the compartment 970. In some embodiments, rails, guides, tracks or other components may be coupled to the frame 52 within each battery compartment 970 for securing batteries 166 and aiding in loading and removal of batteries 166. Note that the batteries 166 may be “hot-swappable” in that they are capable of being removed and replaced without powering down the aircraft 20.

In some embodiments, the frame 52 may comprise an air intake 975 (FIG. 2A) for each compartment 970 that permits air to flow into the compartment 970 for passive cooling of the batteries 166 during flight. In this regard, each compartment extends from an air intake 970 to an air outlet 971 such that air may flow into the intake 975 through the compartment 970 (over the batteries 166 inserted into the compartment 970) and exit through the outlet 971. Other configurations of the air intake 975, battery compartment 970, and air outlet 971 are possible in other embodiments.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A self-piloted, electric aircraft for performing vertical takeoffs and landings, comprising:
a fuselage having a first side and a second side that is opposite to the first side;
a plurality of wings coupled to the fuselage in a tandem-wing configuration, the plurality of wings including at least a first rear wing and a first forward wing positioned on the first side of the fuselage and including at least a second rear wing and a second forward wing positioned on the second side of the fuselage;
a first electrically-powered propeller coupled to the first forward wing and positioned to blow air over the first forward wing;
a second electrically-powered propeller coupled to the second forward wing and positioned to blow air over the second forward wing;
a third electrically-powered propeller coupled to the first rear wing and positioned to blow air over the first rear wing;
a fourth electrically-powered propeller coupled to the second rear wing and positioned to blow air over the second rear wing;
a fifth electrically-powered propeller;
a plurality of flight sensors; and
a controller configured to receive input from the flights sensors and to aviate the aircraft based on the input, the controller further configured to control positioning of each of the propellers such that each of the propellers is rotated from a position for forward flight to a position for vertical flight, and wherein the controller is configured to control each of the propellers such that each of the propellers provides thrust during forward flight and during vertical flight.

2. The aircraft of claim 1, wherein the controller is configured to control pitch, roll, and yaw of the aircraft by selectively adjusting blade speeds of a plurality of the propellers.

3. The aircraft of claim 1, further comprising a plurality of batteries, wherein each of the propellers is electrically coupled to the plurality of batteries.

4. The aircraft of claim 1, wherein the fuselage comprises a frame and a removable passenger module coupled to the frame, the passenger module having at least one passenger seat.

5. The aircraft of claim 1, further comprising a battery electrically coupled to at least one of the propellers, wherein the fuselage has an intake and an outlet, wherein the battery is positioned in a compartment of the fuselage within an airflow path from the intake to the outlet such that air from the intake flows through the compartment to the outlet thereby passively cooling the battery during flight.

6. The aircraft of claim 1, wherein the controller is configured to store predefined data indicative of thrusts to be provided by each of the propellers for different propeller operational states of the aircraft, the controller configured to determine a current propeller operational state of the aircraft, the current propeller operational state indicating whether at least one of the propellers is operational, wherein the controller is configured to analyze the predefined data based on the current propeller operational state and at least one flight parameter to determine a value for controlling at least one of the propellers, and wherein the controller is configured to control a thrust provided by the at least one propeller based on the value.

7. The aircraft of claim 6, wherein the at least one flight parameter includes a value indicating a desired amount of roll, pitch or yaw of the aircraft.

8. The aircraft of claim 1, further comprising:
a light detection and ranging (LIDAR) sensor;
a radio detection and ranging (radar) sensor; and
a camera,
wherein the controller is configured to detect objects based on the LIDAR sensor, radar sensor, and a camera and to aviate the aircraft for avoiding the detected objects.

9. The aircraft of claim 8, wherein the controller is configured to detect objects based on the radar sensor and the camera sensor during forward flight, and wherein the controller is configured to detect objects based on the LIDAR sensor during vertical flight.

10. The aircraft of claim 1, wherein each of the plurality of wings is rotatable relative to the fuselage.

11. The aircraft of claim 10, wherein the controller is configured to rotate each of the plurality of wings, thereby rotating each of the propellers, to transition the aircraft between forward flight and vertical flight.

12. The aircraft of claim 1, wherein an end of the first rear wing forms a winglet for providing yaw stability, and wherein an end of the first second rear wing Banns a winglet for providing yaw stability.

13. The aircraft of claim 12, further comprising at least one landing strut aerodynamically designed for providing yaw stability.

14. The aircraft of claim 1, wherein the fifth electrically-powered propeller is coupled to the first forward wing and positioned to blow air over the first forward wing, and wherein the aircraft further comprises:
a sixth electrically-powered propeller coupled to the second forward wing and positioned to blow air over the second forward wing;
a seventh electrically-powered propeller coupled to the first rear wing and positioned to blow air over the first rear wing; and
an eighth electrically-powered propeller coupled to the second rear wing and positioned to blow air over the second rear wing.

15. The aircraft of claim 14, wherein the first electrically-powered propeller has blades that are configured to rotate in the same direction as blades of the fourth electrically-powered propeller, wherein the second electrically-powered propeller has blades that are configured to rotate in the same direction as blades of the third electrically-powered propeller, and wherein the direction of rotation of the blades of the first electrically-powered propeller and the blades of the fourth electrically-powered propeller is opposite to the direction of rotation of the blades of the second electrically-powered propeller and the blades of the third electrically-powered propeller.

16. The aircraft of claim 15, wherein the fifth electrically-powered propeller has blades that are configured to rotate in the same direction as blades of the eighth electrically-powered propeller, wherein the sixth electrically-powered propeller has blades that are configured to rotate in the same direction as blades of the seventh electrically-powered propeller, and wherein the direction of rotation of the blades of the fifth electrically-powered propeller and the blades of the eighth electrically-powered propeller is opposite to the direction of rotation of the blades of the sixth electrically-powered propeller and the blades of the seventh electrically-powered propeller.

17. The aircraft of claim 14, wherein the fifth electrically-powered propeller is wingtip-mounted on the first forward wing.

18. The aircraft of claim 17, wherein the sixth electrically-powered propeller is wingtip-mounted on the second forward wing.

19. The aircraft of claim 18, wherein the seventh electrically-powered propeller is wingtip-mounted on the first rear wing, and wherein the eighth electrically-powered propeller is wingtip-mounted on the second rear wing.

20. The aircraft of claim 19, wherein the fifth electrically-powered propeller has blades that are configured to rotate in a first direction such that the fifth electrically-powered propeller generates upwash on an inboard side of the fifth electrically-powered propeller.

21. The aircraft of claim 20, wherein the sixth electrically-powered propeller has blades that are configured to rotate in a second direction opposite to the first direction such that the sixth electrically-powered propeller generates upwash on an inboard side of the sixth electrically-powered propeller.

22. The aircraft of claim 21, wherein the seventh electrically-powered propeller has blades that are configured to rotate in the second direction, and wherein the eighth electrically-powered propeller has blades that are configured to rotate in the first direction.

23. The aircraft of claim 22, wherein an end of the first rear wing forms a winglet, and wherein an end of the second rear wing forms a winglet.

24. The aircraft of claim 22, wherein the first electrically-powered propeller has blades that are configured to rotate in the same direction as blades of the fourth electrically-powered propeller, wherein the second electrically-powered propeller has blades that are configured to rotate in the same direction as blades of the third electrically-powered propeller, and wherein the direction of rotation of the blades of the first electrically-powered propeller and the blades of the fourth electrically-powered propeller is opposite to the direction of rotation of the blades of the second electrically-powered propeller and the blades of the third electrically-powered propeller.

25. A method for controlling a vertical takeoff and landing (VTOL) aircraft, comprising:
blowing air over a first forward wing of the VTOL aircraft with a first electrically-powered propeller coupled to the first forward wing during forward flight and vertical flight of the VTOL aircraft;
blowing air over a second forward wing of the VTOL aircraft with a second electrically-powered propeller coupled to the second forward wing during forward flight and vertical flight of the VTOL aircraft;
blowing air over a first rear wing of the VTOL aircraft with a third electrically-powered propeller coupled to the first rear wing during forward flight and vertical flight of the VTOL aircraft;
blowing air over a second rear wing of the VTOL aircraft with a fourth electrically-powered propeller coupled to the second rear wing during forward flight and vertical flight of the VTOL aircraft, wherein the first rear wing and the first forward wing are coupled to a fuselage of the VTOL aircraft and are positioned on first side of a fuselage, and wherein the second rear wing and the second forward wing are coupled to the fuselage and are positioned on a second side of the fuselage opposite to the first side;
providing thrust to the VTOL with a fifth electrically-powered propeller during forward flight and vertical flight of the VTOL aircraft;
sensing parameters indicative of an attitude, altitude, and airspeed of the VTOL aircraft with a plurality of flight sensors; and
controlling the aircraft with a controller based on the sensed parameters, wherein the controlling comprises rotating each of the propellers from a position for forward flight to a position for vertical flight.

26. The method of claim 25, wherein the controlling comprises controlling pitch, roll, and yaw of the VTOL aircraft by selectively adjusting blade speeds of a plurality of the propellers.

27. The method of claim 25, further comprising providing electrical power from a plurality of batteries to at least one of the propellers.

28. The method of claim 25, wherein the fuselage comprises a frame and a removable passenger module coupled to the frame, the passenger module having at least one passenger seat, and wherein the method further comprises:
removing the passenger module from the frame; and
coupling a carp module to the frame.

29. The method of claim 25, wherein the rotating comprises rotating each of the wings, thereby rotating each of the propellers, to transition the VTOL aircraft between forward flight and vertical flight.

30. The method of claim 25, further comprising:
providing electrical power from a battery to at least one of the propellers, the battery positioned within a compartment of the fuselage; and
passively cooling the battery with air flowing through the compartment from an intake of the fuselage to an outlet of the fuselage.

31. The method of claim 30, further comprising inserting the battery into the compartment through the intake or the outlet.

32. The method of claim 25, wherein the first electrically-powered propeller is coupled to the first forward wing, wherein the providing comprises blowing air over the first forward wing of the VTOL aircraft with the fifth electrically-powered propeller, and wherein the method further comprises:
blowing air over the second forward wing of the VTOL aircraft with a sixth electrically-powered propeller coupled to the second forward wing;
blowing air over the first rear wing of the VTOL aircraft with a seventh electrically-powered propeller coupled to the first rear wing; and
blowing air over the second rear wing of the VTOL aircraft with an eighth electrically-powered propeller coupled to the second rear wing.

33. The method of claim 32, further comprising:
rotating blades of the fourth electrically-powered propeller;
rotating blades of the first electrically-powered propeller in the same direction as the blades of the fourth electrically-powered propeller;
rotating blades of the third electrically-powered propeller; and
rotating blades of the second electrically-powered propeller in the same direction as the blades of the third electrically-powered propeller,
wherein the direction of rotation of the blades of the first electrically-powered propeller and the blades of the fourth electrically-powered propeller is opposite to the direction of rotation of the blades of the second electrically-powered propeller and the blades of the third electrically-powered propeller.

34. The method of claim 33, further comprising:
rotating blades of the eighth electrically-powered propeller;
rotating blades of the fifth electrically-powered propeller in the same direction as the blades of the eighth electrically-powered propeller;
rotating blades of the seventh electrically-powered propeller; and
rotating blades of the sixth electrically-powered propeller in the same direction as the blades of the seventh electrically-powered propeller,
wherein the direction of rotation of the blades of the fifth electrically-powered propeller and the blades of the eighth electrically-powered propeller is opposite to the direction of rotation of the blades of the sixth electrically-powered propeller and the blades of the seventh electrically-powered propeller.

35. The method of claim 32, wherein the fifth electrically-powered propeller is wingtip-mounted on the first forward wing, wherein the sixth electrically-powered propeller is wingtip-mounted on the second forward wing, wherein the seventh electrically-powered propeller is wingtip-mounted on the first rear wing, and wherein the eighth electrically-powered propeller is wingtip-mounted on the second rear wing.

36. The method of claim 35, further comprising:
rotating blades of the fifth electrically-powered propeller in a first direction such that the fifth electrically-powered propeller generates upwash on its inboard side; and
rotating blades of the sixth electrically-powered propeller in a second direction that is opposite of the first direction such that the sixth electrically-powered propeller generates upwash on its inboard side.

37. The method of claim 36, further comprising:
rotating blades of the seventh electrically-powered propeller in the second direction; and
rotating blades of the eighth electrically-powered propeller in the first direction.

38. The method of claim 37, further comprising:
rotating blades of the fourth electrically-powered propeller;
rotating blades of the first electrically-powered propeller in the same direction as the blades of the fourth electrically-powered propeller;
rotating blades of the third electrically-powered propeller; and
rotating blades of the second electrically-powered propeller in the same direction as the blades of the third electrically-powered propeller,
wherein the direction of rotation of the blades of the first electrically-powered propeller and the blades of the fourth electrically-powered propeller is opposite to the direction of rotation of the blades of the second electrically-powered propeller and the blades of the third electrically-powered propeller.
